(19) United States
(12) Patent Application Publication
(10) Pub. No.: US 2024/0407894 A1
(43) Pub. Date: Dec. 12, 2024

(54) CONTAINER FOR DENTAL PROPHYLAXIS PASTE

(71) Applicant: Canh Thy Mong Nguyen, Elk Grove, CA (US)

(72) Inventor: Canh Thy Mong Nguyen, Elk Grove, CA (US)

(21) Appl. No.: 18/733,682

(22) Filed: Jun. 4, 2024

Related U.S. Application Data
(60) Provisional application No. 63/506,812, filed on Jun. 7, 2023.

(51) Int. Cl. A61C 17/00

(52) U.S. Cl. CPC A61C 17/005

(57) ABSTRACT

The disclosure includes a container for dental prophylaxis paste comprising a top surface, an open elongated recessed interior portion located below the top surface, wherein the open elongated recessed interior portion is arranged and configured to receive and retain an amount of dental prophylaxis paste, a bottom surface facing opposite the top surface, and an adhesive coupled to the bottom surface, wherein the adhesive is configured to couple the container to a work surface. In some embodiments, the open elongated recessed interior portion is sized and configured to receive a prophylaxis angle to enable transfer of the dental prophylaxis paste to the prophylaxis angle. The open elongated recessed interior portion may define a substantially rectangular shape.

### CROSS-REFERENCE TO RELATED APPLICATIONS

The present application claims priority to U.S. Provisional Patent Application No. 63/506,812 filed on Jun. 7, 2023, entitled “CONTAINER FOR DENTAL PROPHYLAXIS PASTE,” the entire disclosure of which is incorporated by reference herein.

Dental prophylaxis paste, commonly known as “prophy paste,” is used during dental cleanings to polish a patient's teeth. Prophy paste is traditionally available in single-unit-dose, round, cup-shaped containers. The prophy paste is scooped out of the container by an instrument called a prophylaxis, or “prophy,” angle and applied to the patient's teeth while the working end spins at a high velocity to polish the teeth.

### SUMMARY

The disclosure includes a container for dental prophylaxis paste including a top surface and an open elongated recessed interior portion located below the top surface, wherein the open elongated recessed interior portion is arranged and configured to receive and retain an amount of dental prophylaxis paste. The container may also include a bottom surface facing opposite the top surface and an adhesive coupled to the bottom surface, wherein the adhesive is configured to couple the container to a work surface. In some embodiments, the open elongated recessed interior portion is sized and configured to receive a prophylaxis angle to enable transfer of the dental prophylaxis paste to the prophylaxis angle. The open elongated recessed interior portion may define a substantially rectangular shape.

In some embodiments, the open elongated recessed interior portion includes a first side wall defining a first end and a second end located opposite the first end, and a second side wall located opposite the first side wall, the second side wall defining a first end and a second end located opposite the first end. The open elongated recessed interior portion may include a first end wall extending between the first end of the first side wall and the first end of the second side wall. In some embodiments, the open elongated recessed interior portion further includes a second end wall extending between the second end of the first side wall and the second end of the second side wall, wherein the second end wall is located opposite the first end wall.

The open elongated recessed interior portion may include a first rounded edge where the first end wall meets the first end of the first side wall, a second rounded edge where the first end wall meets the first end of the second side wall, a third rounded edge where the second end wall meets the second end of the first side wall, and a fourth rounded edge where the second end wall meets the second end of the second side wall. In some embodiments, the first side wall, the second side wall, the first end wall, and the second end wall each taper inward from the top surface of the container to the bottom surface of the container. The first side wall, the second side wall, the first end wall, and the second end wall may each taper inward at an angle of about 20 degrees. In some embodiments, the open elongated recessed interior portion defines a first width adjacent the top surface of the container and a second width adjacent the bottom surface of the container, wherein the second width is less than the first width. The first width may be about 8 millimeters and the second width may be about 5 millimeters.

In some embodiments, the adhesive is configured to couple to a work surface selected from the group consisting of a glove, a dental instrument, an instrument tray, and combinations thereof. The adhesive may be a pressure-sensitive adhesive. In some embodiments, the adhesive includes a backing detachably coupled to the adhesive such that when the backing is removed, the adhesive is exposed.

The open elongated recessed interior portion may be located within a center portion of the top surface. In some embodiments, the container further includes a rounded perimeter extending from the top surface to the open elongated recessed interior portion. The container may also include a foil shield coupled to the top surface and configured to cover the open elongated recessed interior portion, thereby covering the dental prophylaxis paste prior to use.

In some embodiments, the open elongated recessed interior portion defines a length adjacent the top surface of about 38 millimeters. The open elongated recessed interior portion may define a height of about 7 millimeters. In some embodiments, the open elongated recessed interior portion is sized and configured to receive the prophylaxis angle multiple times to enable multiple transfers of the dental prophylaxis paste to the prophylaxis angle, such that following use of the container in a dental procedure, substantially an entirety of the amount of dental prophylaxis paste has been transferred to the prophylaxis angle. The amount of dental prophylaxis paste may be about 0.5 milliliters. In some embodiments, the open elongated recessed interior portion is sized and configured to correspond to a working end of the prophylaxis angle such that when the prophylaxis angle contacts the open elongated recessed interior portion, the working end collects the dental prophylaxis paste without excess dental prophylaxis paste gathering on an exterior of the working end.

The foregoing, and other features and advantages of the invention, will be apparent from the following, more particular description of the preferred embodiments of the invention, the accompanying drawings, and the claims.

### BRIEF DESCRIPTION OF THE DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a user holding a tool and a first container for dental prophylaxis paste, according to some embodiments.

FIG. 2 illustrates a user holding a tool and a second container for dental prophylaxis paste, according to some embodiments.

FIG. 3A illustrates a top view of a tool accessing the second container containing dental prophylaxis paste, according to some embodiments.

FIG. 3B illustrates a side view of a tool accessing the second container containing dental prophylaxis paste, according to some embodiments.

FIG. 3C illustrates a top view of a tool accessing the first container containing dental prophylaxis paste, according to some embodiments.

FIG. 3D illustrates a side view of a tool accessing the first container containing dental prophylaxis paste, according to some embodiments.

FIG. 4 illustrates a top perspective view of the first container, according to some embodiments.

FIG. 5 illustrates a bottom and first side perspective view of the first container, according to some embodiments.

FIG. 6 illustrates a top and side perspective view of the first container holding dental prophylaxis paste, according to some embodiments.

FIGS. 7 and 8 illustrate top views of the first container, according to some embodiments.

FIG. 9 illustrates a side view of the first container, according to some embodiments.

FIG. 10 illustrates an end view of the first container, according to some embodiments.

FIG. 11 illustrates a top and first end perspective view of the first container, according to some embodiments.

FIG. 12 illustrates a top perspective view of the first container, according to some embodiments.

### DETAILED DESCRIPTION

Currently, single-dose dental prophylaxis paste (“prophy paste”) containers are in the shape of a cup that is approximately 15 mm in diameter and 10 mm deep. The container is filled with the prophy paste and sealed with foil prior to use during dental cleaning procedures. The shape of the cup can cause several problems, including, but not limited to, the following.

First, the instrument used to scoop the paste, called the prophylaxis angle (“prophy angle”), has an elongated head that interferes with the edge of the cup due to the cup's round shape and small diameter. Further, the prophy angle is unable to fit deep into the cup to reach the bottom portion of the cup. This interference only allows the utilization of the uppermost layer of paste around the inner walls, resulting in wasted paste.

Second, for more paste to be scooped out, the cup must be squeezed in order to push the paste upward. Even so, typically, fifty percent of the paste remains inaccessible, unused, and ultimately discarded.

Third, once the cup is squeezed, the shape of the container is deformed. Existing methods for holding the cup include various ring attachments worn on the finger, into which the cup is inserted. Once the cup is squeezed, it will no longer fit into the prophy cup ring holder, rendering the ring holder useless. Further, when purchasing a box of two hundred cups, only a small number of rings, for example, two or three, are provided. This quantity is not only inadequate but also problematic as most of these rings are made of plastic, rendering them incapable of undergoing complete heat sterilization to safely be reused.

Fourth, the cylindrical shape is very difficult to hold during the procedure (hence, the use of a prophy cup ring holder), and is often dropped and then must be discarded due to best infection control practices.

Fifth, due to the awkward maneuver required to scoop the paste out of the container, excess paste often adheres to the outside perimeter of the prophy angle working end, resulting in splatter as soon as polishing begins.

The device disclosed herein aims to solve the challenges associated with traditional prophy paste containers by providing an elongated container that better accommodates the prophy angle tool, resulting in reduced waste and increased case of use.

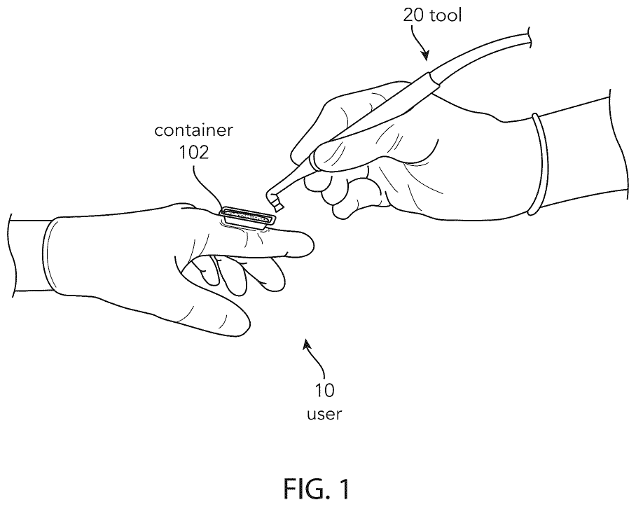

FIG. 1 shows a user 10, such as a dentist or dental hygienist, holding a tool 20 and features a container 102 adhered to a glove worn by the user 10. In some embodiments, the container 102 is a single-use container for dental prophylaxis paste, or “prophy paste,” and the tool 20 is a prophylaxis, or “prophy,” angle. Prophy angles are commonly used during dental cleaning procedures to apply prophy paste to a patient's teeth. The head of the prophy angle may include a rounded brush, a rubber cup, or a similar element configured to gather prophy paste and then spin at a high velocity to polish the patient's teeth. As illustrated in FIG. 1, the container 102 may define a substantially rectangular shape. The container 102 will be discussed in greater detail later in the disclosure.

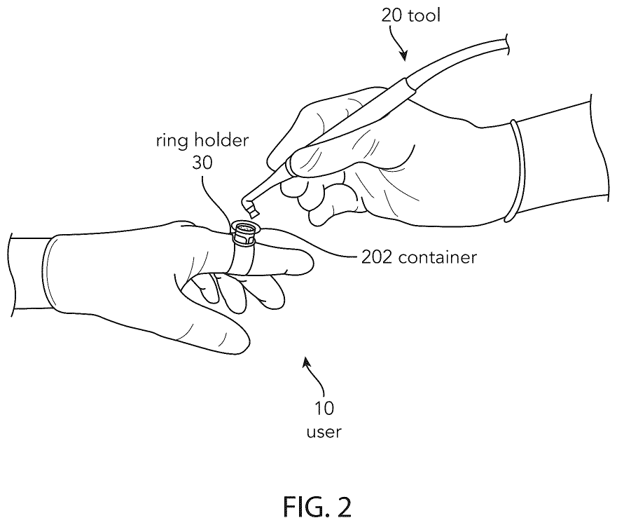

FIG. 2 is similar to FIG. 1 in that it includes the user 10 and the tool 20; however, FIG. 2 shows a different container 202 rather than the container 102 of FIG. 1. The container 202 may define a rounded cup-like shape, as illustrated. In some embodiments, the shape of the container 202 is difficult for the user 10 to hold while also holding the tool 20. Accordingly, the user 10 may wear a ring holder 30 designed to hold the container 202. In some embodiments, the ring holder 30 is worn by the user 10 and includes a cup or similar element configured to receive the container 202.

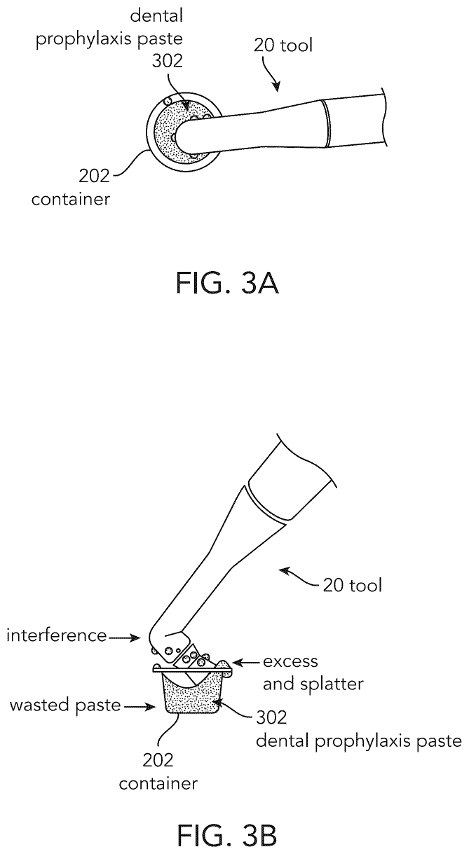

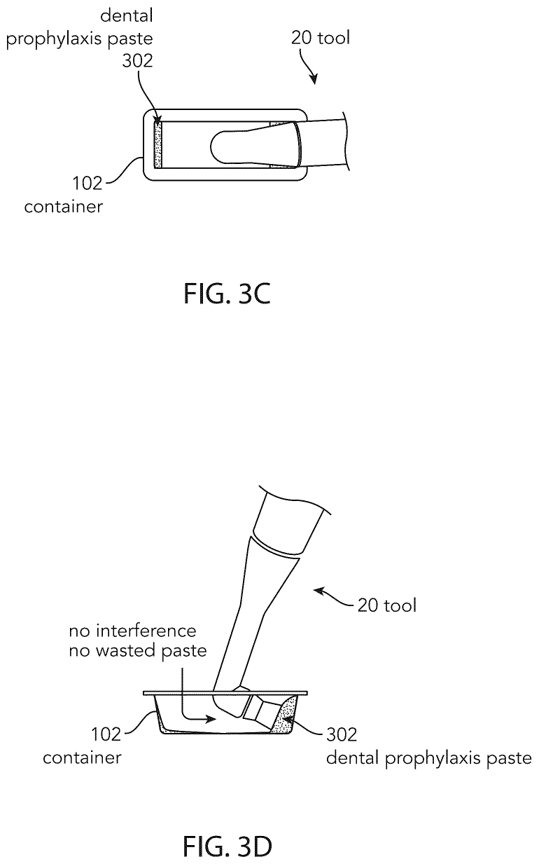

FIGS. 3A and 3B show the tool 20 accessing the container 202 containing dental prophylaxis paste 302. Specifically, FIG. 3A shows a top view and FIG. 3B shows a side view of how the tool 20 interacts with the container 202. As illustrated in FIGS. 3A and 3B, the rounded cup-like shape of the container 202 presents some barriers that prevent the tool 20 from obtaining the dental prophylaxis paste 302. For example, the angled head of the tool 20 may interfere with the perimeter around the opening of the container 202, because the opening of the container 202 is smaller than the elongated head of the tool 20. While the tool 20 may reach the top layer of the dental prophylaxis paste 302 within the container 202, this interference prevents the tool 20 from reaching down into the container 202 to access more dental prophylaxis paste 302, resulting in waste. Further, as the user 10 maneuvers the tool 20 to scoop out the dental prophylaxis paste 302, there is a high chance of excess paste 302 gathering around the perimeter of the container 202 and at the end of the tool 20. When the tool 20 is turned on and the end begins rotating, the excess paste 302 may splatter, resulting in a mess that the user 10 must clean up.

FIGS. 3C and 3D show the tool 20 accessing the container 102 containing dental prophylaxis paste 302. Specifically, FIG. 3C shows a top view and FIG. 3D shows a side view of how the tool 20 interacts with the container 102. In contrast to the container 202, the elongated rectangular shape of the container 102 shown in FIGS. 3C and 3D aligns with the elongated shape of the angled head of the tool 20, so there is no interference when the tool 20 accesses the container 102. Due to the lack of interference, the tool 20 is able to extend down into the container 102 and reach most of the dental prophylaxis paste 302, reducing the amount of wasted paste 302 when compared to the container 202. The container 102 may present numerous advantages over the container 202.

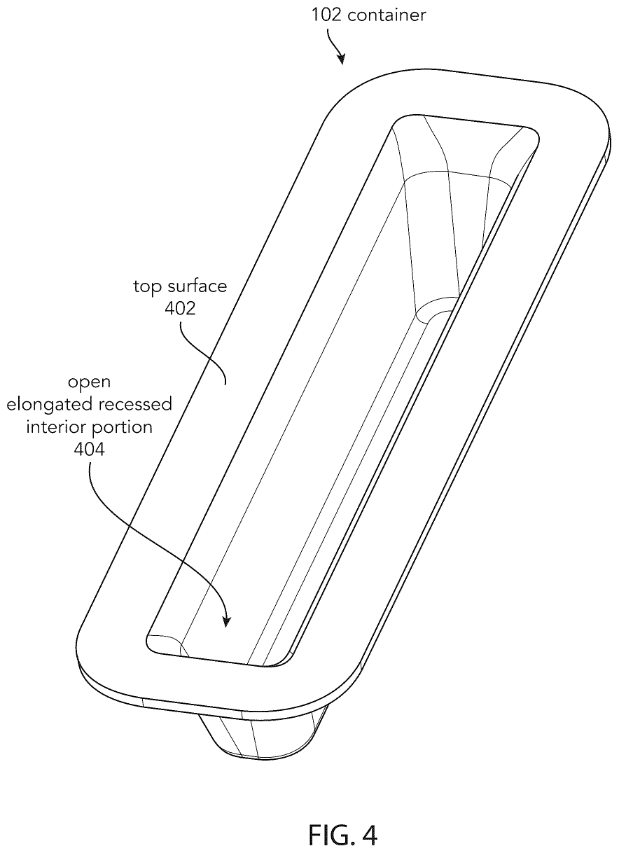

FIG. 4 shows a perspective view of the container 102. As illustrated, the container 102 may include a top surface 402 and an open elongated recessed interior portion 404 located below the top surface 402. In some embodiments, the open elongated recessed interior portion 404 is located within a center portion of the top surface 402. The open elongated recessed interior portion 404 may be arranged and configured to receive and retain an amount of dental prophylaxis paste 302, as illustrated in FIG. 3B. In some embodiments, the open elongated recessed interior portion 404 defines a substantially rectangular shape, as illustrated in FIG. 4. As previously discussed, the substantially rectangular shape may be advantageous because it corresponds to the shape of the tool 20, allowing the tool 20 easy access to the dental prophylaxis paste 302 within the open elongated recessed interior portion 404. In some embodiments, the container 102 is made of a plastic material, such as vacuum-formed plastic. The material forming the container 102 may be a rigid material such that the container 102 is resistant to squeezing, unlike the container 202.

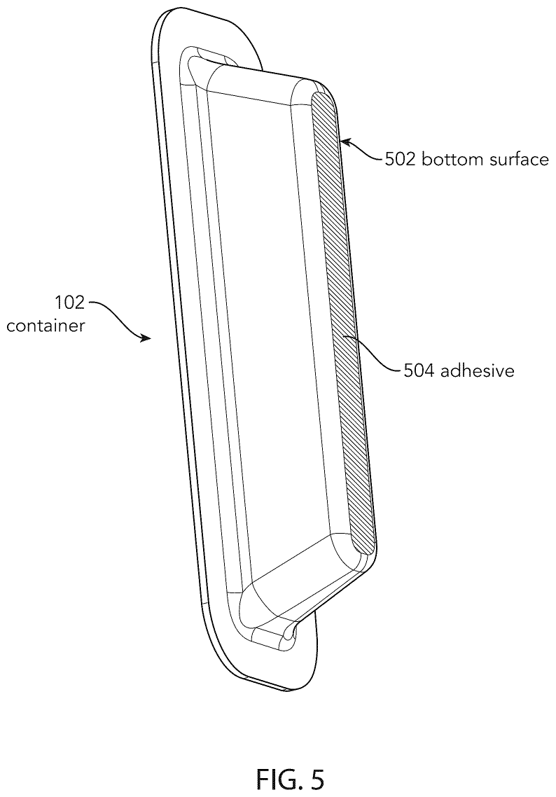

FIG. 5 shows another perspective view of the container 102, including the bottom surface 502. In some embodiments, the bottom surface 502 faces opposite the top surface 402. The container 102 may also include an adhesive 504 coupled to the bottom surface 502, as shown in FIG. 5. In some embodiments, the adhesive 504 is configured to cover substantially an entirety of the bottom surface 502, as demonstrated in FIG. 5. The adhesive 504 may be configured to cover less than the entire bottom surface 502. For example, the adhesive 504 may be concentrated to only a perimeter of the bottom surface 502, only a center portion of the bottom surface 502, and the like.

In some embodiments, the adhesive 504 is configured to couple the container 102 to a work surface. The adhesive 504 may be configured to removably couple the container 102 to a work surface, such that the container 102 may be adhered to a first work surface, then removed and adhered to a different work surface, or re-adhered to the first work surface. This may allow the user 10 to reposition the container 102 on the work surface without having to discard the container 102 and start over with a fresh container 102. The work surface may include any number of suitable surfaces such as, but not limited to, a gloved hand of a dental practitioner (as shown in FIG. 1), an instrument tray, and/or a dental instrument, such as a mirror. In some embodiments, the use of the adhesive 504 removes the need for an accessory holder, such as the ring holder 30 shown in FIG. 2, to help the user 10 keep the container 102 in a convenient location for use.

The adhesive 504 may include a pressure-sensitive adhesive. Stated differently, the adhesive 504 may be configured to adhere to a working surface under the influence of pressure alone, without needing to be activated by other means. As such, the container 102 may be used as soon as the bottom surface 502, including the adhesive 504, is pressed onto the working surface. In some embodiments, the container 102 is manufactured with the adhesive 504 coupled to the bottom surface 502, and the adhesive 504 includes a backing, such that when a practitioner is ready to use the container 102, the practitioner simply needs to remove the backing to expose the adhesive 504 and stick the container 102 to the desired surface.

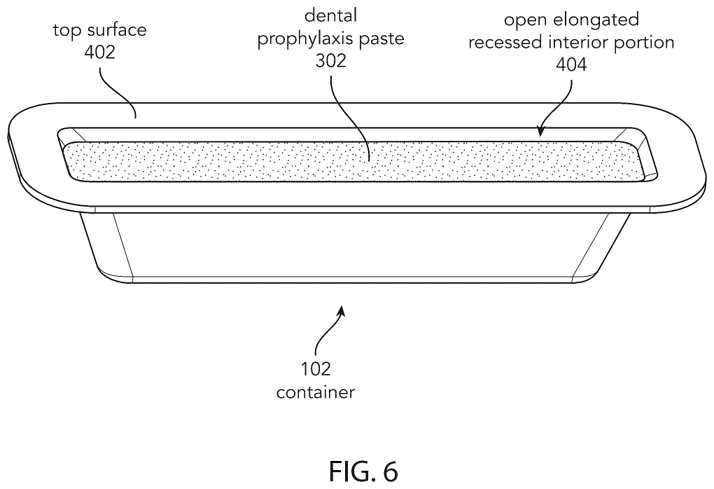

FIG. 6 shows a perspective side view of the container 102, and includes the dental prophylaxis paste 302. The container 102 may be configured to hold about 0.5 mL of dental prophylaxis paste 302, compared to the quantity available in traditional prophy paste containers, which is usually around 1 mL. In some embodiments, the container 102 is configured to hold between about 0.5 mL and 0.8 mL of dental prophylaxis paste 302. As previously discussed in this disclosure, traditional prophy paste containers are ill-suited to allow practitioners to retrieve the entire available quantity of prophy paste. As a result, most dental cleanings are carried out with only about half of the available quantity of paste, which has proven sufficient to polish teeth. As a result, the disclosed container 102 includes only about half of the traditional quantity of dental prophylaxis paste 302, which may reduce cost and waste while still providing a sufficient amount of paste 302 to polish a patient's teeth. Of course, practitioners can always use multiple containers 100 of dental prophylaxis paste 302 during a cleaning.

As discussed with reference to FIGS. 1 and 3B, in some embodiments, the open elongated recessed interior portion 404 is sized and configured to receive a prophylaxis angle tool, such as the tool 20, to enable the transfer of the dental prophylaxis paste 302 to the tool 20. The open elongated recessed interior portion 404 may be sized and configured to correspond to a working end of the tool 20 such that when the tool 20 contacts the open elongated recessed interior portion 404, the working end collects the dental prophylaxis paste 302 without excess dental prophylaxis paste 302 gathering on an exterior of the working end. Stated differently, the cross-section of the open elongated recessed interior portion 404 may be sized to match, or be just slightly larger than, the cross-section of the working end of the tool 20 to facilitate thorough collection of the paste 302 without excess gathering on the exterior of the working end. Excess paste 302 on the outside of the working end of the prophylaxis angle can result in the paste 302 splattering when the working end begins to spin, resulting in a mess for the patient and/or practitioner.

In some embodiments, the open elongated recessed interior portion 404 is sized and configured to receive the tool 20 multiple times to enable multiple transfers of the dental prophylaxis paste 302 to the tool 20, such that following the use of the container 102 in a dental procedure, substantially an entirety of the amount of dental prophylaxis paste 302 has been transferred to the tool 20, resulting in minimal “leftover” paste 302.

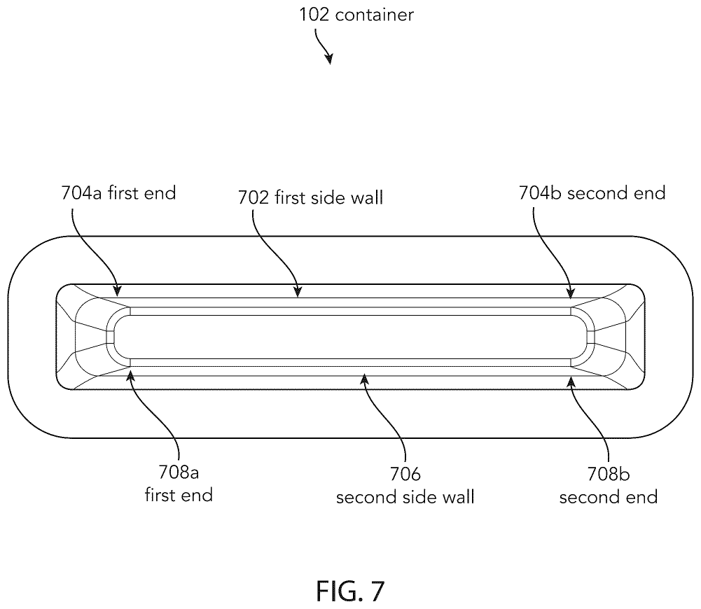

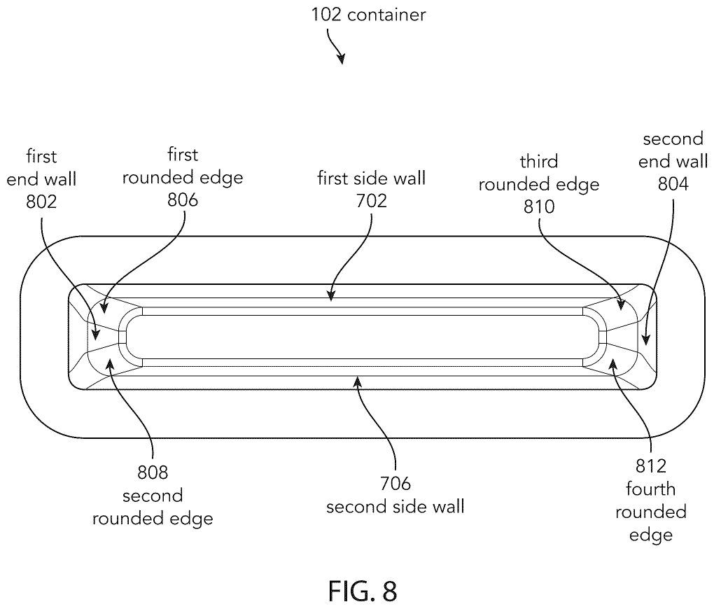

FIGS. 7 and 8 illustrate top views of the container 102 to better illustrate some elements of the open elongated recessed interior portion 404. In some embodiments, the open elongated recessed interior portion 404 includes a first side wall 702 and a second side wall 706. As shown in FIG. 7, the first side wall 702 may include a first end 704a and a second end 704b located opposite the first end 704a. Similarly, the second side wall 706 may include a first end 708a and a second end 708b located opposite the first end 708a. In some embodiments, the open elongated recessed interior portion 404 also includes a first end wall 802 and a second end wall 804 located opposite the first end wall 802, as shown in FIG. 8. The first end wall 802 may be configured to extend between the first end 704a of the first side wall 702 and the first end 708a of the second side wall 706. The second end wall 804 may be configured to extend between the second end 704b of the first side wall 702 and the second end 708b of the second side wall 706.

As also shown in FIG. 8, the open elongated recessed interior portion 404 may include a first rounded edge 806, a second rounded edge 808, a third rounded edge 810, and a fourth rounded edge 812. In some embodiments, the first rounded edge 806 is located where the first end wall 802 meets the first side wall 702 and the second rounded edge 808 is located where the first end wall 802 meets the second side wall 706. Similarly, the third rounded edge 810 may be located where the second end wall 804 meets the first side wall 702, and the fourth rounded edge 812 may be located where the second end wall 804 meets the second side wall 706.

Having rounded edges, rather than blunt edges and corners, within the open elongated recessed interior portion 404 may make it easier for the tool 20 to scoop out the dental prophylaxis paste 302 by better matching the shape of the open elongated recessed interior portion 404 with the shape of the working end of the tool 20. In addition to the shape of the container 102, the consistency of the dental prophylaxis paste 302 may contribute to easier scooping. In some embodiments, the dental prophylaxis paste 302 provided within the container 102 has a lighter, softer, and more malleable texture than traditional prophy paste, which can be more solid and difficult to scoop.

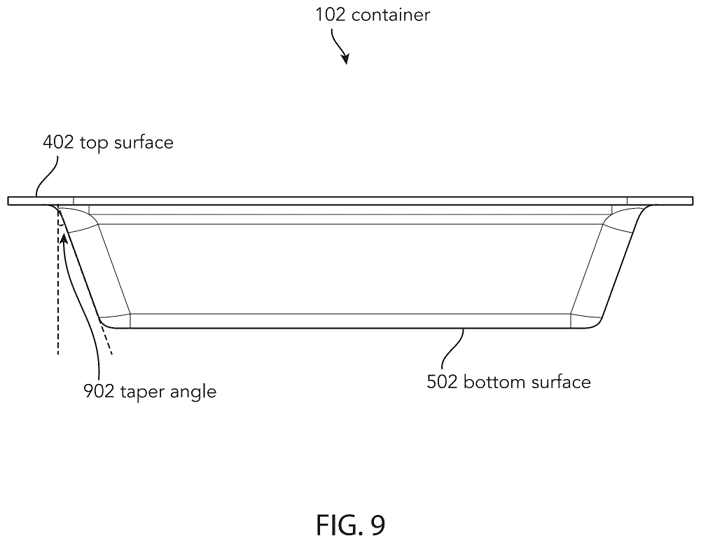

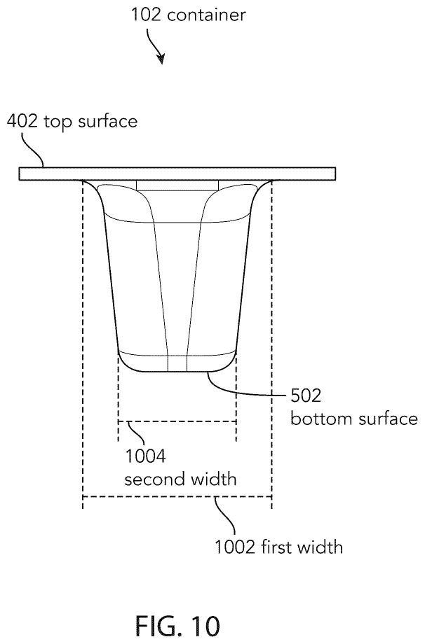

FIG. 9 illustrates a side view of the container 102 and demonstrates that, in some embodiments, the walls of the open elongated recessed interior portion 404, including the first side wall 702, the second side wall 706, the first end wall 802, and/or the second end wall 804, taper inward from the top surface 402 to the bottom surface 502. Stated another way, the open elongated recessed interior portion 404 may be narrower along the bottom surface 502 than it is adjacent the top surface 402, as also shown in FIG. 10. In some embodiments, the taper angle 902 is about 20 degrees. The taper angle 902 may define any angle between 5 degrees and 45 degrees. The taper angle 902 may enable an ergonomic grip on the tool 20 while retrieving the dental prophylaxis paste 302 from the container 102.

FIG. 10 further illustrates the tapered nature of the open elongated recessed interior portion 404 by showing that, in some embodiments, the open elongated recessed interior portion 404 defines a first width 1002 adjacent the top surface 402 of the container 102 and a second width 1004 adjacent the bottom surface 502 of the container 102. The second width 1004 may be less than the first width 1002, as shown in FIG. 10. In some embodiments, the first width 1002 is about 8 mm and the second width 1004 is about 5 mm. In terms of other possible dimensions of the container 102, the open elongated recessed interior portion 404 may define a length adjacent the top surface 402 of about 38 mm. The container 102 may define a total length adjacent the top surface 402 of about 41 mm. Accordingly, the top surface 402 may define a perimeter having a 1.5 mm width around the open elongated recessed interior portion 404. The open elongated recessed interior portion 404 may define a height, or depth, of about 7 mm and an internal width from about 5 mm to about 8 mm.

It should be noted that the physical dimensions included in this disclosure are intended to be non-limiting examples. Further, the use of “about” prior to each dimension indicates an acceptable margin of error for each measurement of +/−5 mm. For example, the open elongated recessed interior portion 404 may define a length adjacent the top surface 402 between 33 mm and 43 mm, and the container 102 may define a total length adjacent the top surface 402 between 36 mm and 46 mm.

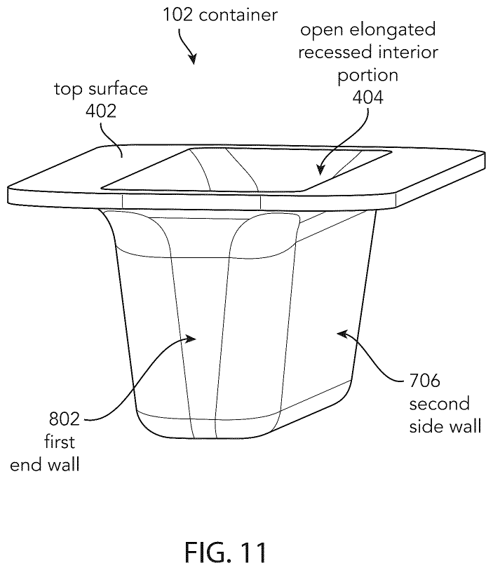

FIG. 11 illustrates another perspective view of the container 102 including the top surface 402, the open elongated recessed interior portion 404, the first end wall 802, and the second side wall 706. In some embodiments, the container 102 includes a rounded perimeter extending from the top surface 402 into the open elongated recessed interior portion 404, such that there is not a sharp drop-off from the top surface 402 into the open elongated recessed interior portion 404.

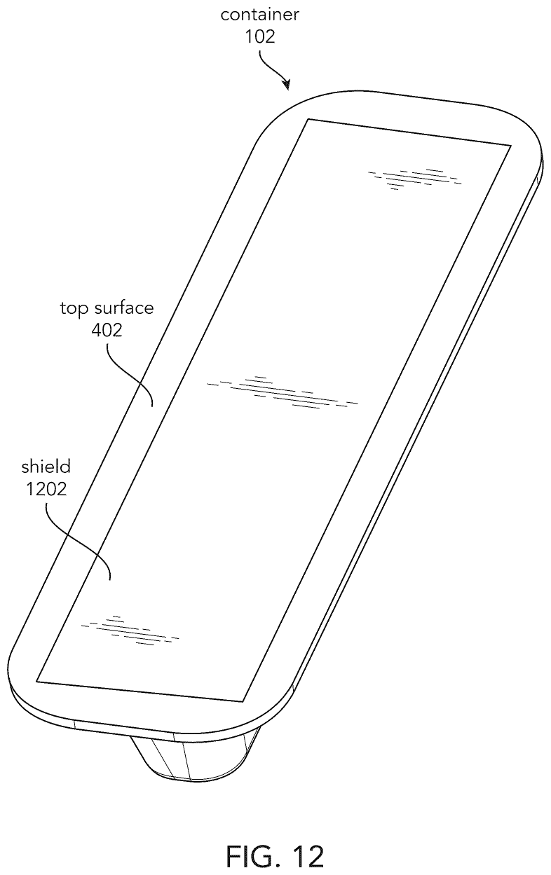

FIG. 12 shows another perspective view of the container 102, and demonstrates that, in some embodiments, the container 102 also includes a shield 1202 coupled to the top surface 402. The shield 1202 may be configured to cover the open elongated recessed interior portion 404, thereby covering the dental prophylaxis paste 302 prior to use to maintain a sterile environment within the container 102. In some embodiments, the shield 1202 is adhered to the top surface 402 and is made of foil, plastic, or any other suitable material.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “adjacent” means “next to or adjoining.” For example, the disclosure includes “the open elongated recessed interior portion 404 may be narrower along the bottom surface 502 than it is adjacent the top surface 402 . . . ” In this context, “adjacent the top surface” refers to the portion of the open elongated recessed interior portion located next to the top surface of the container.

The term “substantially” is used to mean “completely or nearly completely.” For example, the disclosure includes “the open elongated recessed interior portion 404 defines a substantially rectangular shape . . . ” In this context, “substantially rectangular” means “nearly completely rectangular” such that the shape of the open elongated recessed interior portion, with the rounded edges and corners, is considered “substantially rectangular.”

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

I claim:

1. A container for dental prophylaxis paste, comprising:
a top surface;
an open elongated recessed interior portion located below the top surface, wherein the open elongated recessed interior portion is arranged and configured to receive and retain an amount of dental prophylaxis paste;
a bottom surface facing opposite the top surface; and
an adhesive coupled to the bottom surface, wherein the adhesive is configured to couple the container to a work surface.

2. The container of claim 1, wherein the open elongated recessed interior portion is sized and configured to receive a prophylaxis angle to enable transfer of the dental prophylaxis paste to the prophylaxis angle.

3. The container of claim 2, wherein the open elongated recessed interior portion defines a substantially rectangular shape.

4. The container of claim 2, wherein the open elongated recessed interior portion comprises:
a first side wall defining a first end and a second end located opposite the first end;
a second side wall located opposite the first side wall, the second side wall defining a first end and a second end located opposite the first end;
a first end wall extending between the first end of the first side wall and the first end of the second side wall; and
a second end wall extending between the second end of the first side wall and the second end of the second side wall, wherein the second end wall is located opposite the first end wall.

5. The container of claim 4, wherein the open elongated recessed interior portion comprises:
a first rounded edge where the first end wall meets the first end of the first side wall;
a second rounded edge where the first end wall meets the first end of the second side wall;
a third rounded edge where the second end wall meets the second end of the first side wall; and
a fourth rounded edge where the second end wall meets the second end of the second side wall.

6. The container of claim 4, wherein the first side wall, the second side wall, the first end wall, and the second end wall each taper inward from the top surface of the container to the bottom surface of the container.

7. The container of claim 6, wherein the first side wall, the second side wall, the first end wall, and the second end wall each taper inward at an angle of about 20 degrees.

8. The container of claim 4, wherein the open elongated recessed interior portion defines a first width adjacent the top surface of the container and a second width adjacent the bottom surface of the container, wherein the second width is less than the first width.

9. The container of claim 8, wherein the first width is about 8 millimeters and the second width is about 5 millimeters.

10. The container of claim 1, wherein the adhesive is configured to couple to a work surface selected from the group consisting of a glove, a dental instrument, an instrument tray, and combinations thereof.

11. The container of claim 10, wherein the adhesive comprises a pressure-sensitive adhesive.

12. The container of claim 10, wherein the adhesive includes a backing detachably coupled to the adhesive such that when the backing is removed, the adhesive is exposed.

13. The container of claim 1, wherein the open elongated recessed interior portion is located within a center portion of the top surface.

14. The container of claim 13, further comprising a rounded perimeter extending from the top surface to the open elongated recessed interior portion.

15. The container of claim 13, further comprising a foil shield coupled to the top surface and configured to cover the open elongated recessed interior portion, thereby covering the dental prophylaxis paste prior to use.

16. The container of claim 1, wherein the open elongated recessed interior portion defines a length adjacent the top surface of about 38 millimeters.

17. The container of claim 1, wherein the open elongated recessed interior portion defines a height of about 7 millimeters.

18. The container of claim 2, wherein the open elongated recessed interior portion is sized and configured to receive the prophylaxis angle multiple times to enable multiple transfers of the dental prophylaxis paste to the prophylaxis angle, such that following use of the container in a dental procedure, substantially an entirety of the amount of dental prophylaxis paste has been transferred to the prophylaxis angle.

19. The container of claim 18, wherein the amount of dental prophylaxis paste is about 0.5 milliliters.

20. The container of claim 2, wherein the open elongated recessed interior portion is sized and configured to correspond to a working end of the prophylaxis angle such that when the prophylaxis angle contacts the open elongated recessed interior portion, the working end collects the dental prophylaxis paste without excess dental prophylaxis paste gathering on an exterior of the working end.
